(19) United States
(12) Patent Application Publication
(10) Pub. No.: US 2010/0017186 A1
(43) Pub. Date: Jan. 21, 2010

(54) Noise Model Method of Predicting Mismatch Effects on Transient Circuit Behaviors

(76) Inventors: Jaeha Kim, Mountain View, CA (US); Mark A. Horowitz, Menlo Park, CA (US); Kevin D. Jones, Hayward, CA (US)

Correspondence Address: MORGAN LEWIS & BOCKIUS LLP/RAMBUS INC., 2 PALO ALTO SQUARE, 3000 EL CAMINO REAL, SUITE 700, PALO ALTO, CA, 94306, US

(21) Appl. No.: 12/528,616

(22) PCT Filed: Feb. 28, 2008
(86) PCT No.: PCT/US08/55286

§ 371 Date: Aug. 25, 2009

Related U.S. Application Data
(60) Provisional application No. 60/892,832, filed on Mar. 2, 2007.

(51) Int. Cl. G06F 17/50

(52) U.S. Cl. 703/14

(57) ABSTRACT

A method of simulating device mismatch effects on transient circuit behaviors utilizes a circuit model corresponding to an electronic circuit. The circuit model includes a plurality of circuit elements and one or more noise sources. The noise sources have noise characteristics that correspond to device mismatch effects associated with the circuit elements. A noise analysis is performed on the circuit model to generate a noisy steady-state waveform of a selected output of the electronic circuit. Then, the noisy steady-state waveform is translated into a prediction of the variation of a respective circuit parameter associated with the electronic circuit.

### FIELD

The subject matter herein generally relates to simulation methods for predicting mismatch effects of circuits.

### BACKGROUND

Device mismatch is the difference between two or more nominally identical devices. Device mismatch may be caused by non-uniformity in device fabrication. Device mismatch may also be expressed as uncertainty in the value of device parameters. For MOSFET transistors, device mismatch may affect device parameters such as threshold voltage, current factor, gate oxide thickness, doping levels in one or more device regions, source/drain junction depth, and so on.

To simulate random effects in circuit behaviors due to device mismatches, for example, clock skews, receiver offsets, nonlinearities of analog-to-digital converters (ADCs), nonlinearities of digital-to-analog converters (DACs), and nonlinearities of phase interpolators, circuit designers typically run Monte-Carlo simulations. A Monte-Carlo simulation is a collection of repeated simulations with randomized circuit parameters such as resistance, capacitance, inductance, and threshold voltage (Vth) and current factor (k) of a transistor. The estimation accuracy depends on the number of runs. Typically a few hundred simulations or more are required to obtain reasonably accurate information about the impact of device mismatches on circuit operation. For DC or AC analysis, this poses little problem since each simulation run executes reasonably fast. However, for transient analysis, which measures the circuit's voltage or current response over time, a Monte-Carlo simulation can be prohibitively time-consuming.

A faster method of simulating random transient behaviors of circuits due to device mismatches is therefore needed.

### BRIEF DESCRIPTION OF THE DRAWINGS

For a better understanding, reference should be made to the following detailed description taken in conjunction with the accompanying drawings, in which:

FIG. 1 illustrates the translation of circuit elements with DC-mismatch statistics into circuit elements with noise sources, sometimes called pseudo-equivalent AC noise sources.

FIG. 2 is an embodiment of the translation of the output noise power spectral density (PSD) to DC variation of a voltage of interest in the circuit.

FIG. 3 is an embodiment of a buffer chain.

FIG. 4 is an embodiment of a modeled buffer chain combining pseudo-equivalent AC noise sources with the model elements shown in FIG. 1.

FIG. 5 shows how the output of a circuit simulator can be used to generate the delay variation of the buffer chain in FIG. 3 using a frequency-domain periodic noise analysis.

FIG. 6 shows how a circuit simulator can be used to generate the delay variation of the buffer chain in FIG. 3 using a time-domain periodic noise analysis.

FIG. 7 is a flow chart illustrating an embodiment of the method of simulating device mismatch effects on transient circuit behaviors described herein.

FIG. 8 shows how the variation of the period of a ring oscillator due to device mismatches can be determined using either a frequency domain analysis or a time domain analysis.

FIG. 9 illustrates a computer that can be used to perform the method described herein.

Like reference numerals refer to the same or similar components throughout the several views of the drawings.

### DETAILED DESCRIPTION OF EMBODIMENTS

A method of simulating device mismatch effects on transient circuit behaviors includes providing a circuit model that corresponds to an electronic circuit. The circuit model includes a plurality of circuit elements and one or more artificial noise sources that are used for modeling device mismatch effects. These noise sources are artificial in a sense that their characteristics do not correspond to physical noises such as thermal noise, flicker noise, or shot noise that vary over time, but rather their characteristics correspond to device mismatch effects associated with the circuit elements that are static over time (DC) in nature. A periodically time varying noise analysis is performed on the circuit model to generate a simulation output representing a noisy periodic waveform at a selected output of the electronic circuit. The noisy periodic waveform is translated into a variation of a respective circuit parameter associated with the electronic circuit. The variation corresponds to a predicted magnitude of the device mismatch effects.

In some embodiments, the noisy periodic waveform is represented in the frequency-domain by a Fourier-series representation of a nominal periodic steady-state waveform and a noise power spectral density (PSD) of the selected output of the electronic circuit. In other embodiments, the noisy periodic waveform is represented in the time domain by a time-series representation of the nominal periodic steady-state waveform and the RMS variation of noise within the nominal periodic steady-state waveform at multiple points in time.

In some embodiments, mismatch parameters represent variations or uncertainties in device characteristics that are static over time (DC offsets) and noise parameters represent unwanted signals that vary over time (AC noises).

In some embodiments, the artificial noise sources in the circuit model include one or more noise sources having AC noise parameters that correspond to one or more device mismatches parameters. These AC noise parameters (e.g., noise scaling factors) are sometimes herein called pseudo-equivalent AC noise parameters, and the noise sources are sometimes herein called pseudo-equivalent AC noise sources. Noise sources having pseudo-equivalent AC noise parameters can replace DC offsets in voltage or current, or combinations thereof.

In this document, the PSD of a noise signal is also called the PSD of the noise source that produces the noise signal.

In some embodiments, the pseudo-equivalent AC noise sources that are added to the circuit model to model device mismatches are 1/f noise sources, which produce “1/f noise.” The power (i.e., PSD) of the 1/f noise produced by 1/f noise sources decreases with frequency (f) in accordance with 1/f. In other embodiments, the pseudo-equivalent AC noises sources are

$$\frac{1}{{f}^{n}}$$

noise sources, where n is a number greater than one. The power (i.e., power spectral density) of the noise

$$( \frac{1}{{f}^{n}} noise )$$

produced by

$$\frac{1}{{f}^{n}}$$

noise sources decreases with frequency in accordance with

$$\frac{1}{{f}^{n}} .$$

### These 1/f and

$$\frac{1}{{f}^{n}}$$

noise sources are sometimes called low frequency noise sources because their PSD at a predefined low frequency f₁, where f₁ is typically at or below 100 Hz, is much greater (e.g., by at least a factor of 100) than their PSDs at frequencies beyond the fundamental operating frequency (f₀) of the periodic circuit whose operation is being simulated.

In some embodiments, one or more of the pseudo-equivalent AC noise parameters varies in response to a bias level of one or more of the circuit elements.

In some embodiments, a circuit simulator performs a periodically time varying noise analysis on the modeled circuit.

In some embodiments, a sensitivity analysis is performed on the modeled circuit that provides a breakdown of individual noise source contributions to a total noise of the selected output of the circuit. The breakdown can be used to determine which device mismatch most influences a respective circuit parameter of interest.

In some embodiments, the parameter of interest is voltage or current, while in other embodiments the parameter of interest can be current, time delay, signal frequency, signal period, signal phase, differential non-linearity (DNL), integral non-linearity (INL) or a combination thereof.

In some embodiments, the noisy periodic waveform is decomposed into a proportional noise term and an integral noise term so that different types of device mismatch contributions to the circuit's behavior can be calculated separately.

In some embodiments, the two or more pseudo-equivalent noise sources (i.e., AC noise sources having AC noise parameters that correspond to one or more device mismatch parameters) are correlated and the correlations are realized by linear combinations of common sets of independent noise sources.

In some embodiments, the mismatch effects on two or more selected outputs of an electronic circuit are correlated and the correlations are estimated using the breakdown of individual noise source contributions to a total noise of each output of the circuit.

In another aspect of the invention, a computer-readable medium includes instructions for performing methods of simulating device mismatch effects on transient circuit behaviors.

In some embodiments, variations of a circuit parameter or performance parameter that may vary due to device mismatch are analyzed. Some mismatch effects of interest are deviations from nominal values, such as variations in delay (e.g., delay of a logic path or clock skews), variations in frequency (e.g., frequency of a ring oscillator), variations of voltage offset (e.g., in a regenerative amplifier or comparator).

Some other mismatch effects of interest are parameters describing degradations in performance due to device mismatches. Examples of such parameters include integral nonlinearities (INL) and differential nonlinearities (DNL) of digital-to-analog converters (DAC) and analog-to-digital converters (ADC). INL and DNL are measurements of linearity of conversion between digital values and analog quantities such as voltage, current, and phase. In an ideal D/A converter, incrementing the digital code by 1 changes the output voltage by an amount that does not vary across the device's permitted range. Similarly, in an A/D converter, the digital value ramps smoothly as the input is linearly swept across its entire range. DNL measures the deviation from the ideal. Similarly, INL measures another aspect of deviation from the ideal. An ideal converter has a DNL of 0 (zero) and an INL of 0.

Some circuit designs use replica circuits to measure one or more characteristics of a main circuit in order not to interfere with the operation of the main circuit. Any mismatch between the replica and the main circuit may introduce unintended degradation or deviation from the nominal behavior of a circuit or system. For example, in a phase-locked loop (PLL) that uses a replica-biased charge pump or voltage-controlled oscillator (VCO), mismatch between the replica and the main circuit can cause increased static phase offset, increased clock jitter, degradation in the supply noise rejection, and/or suboptimal scaling of PLL bandwidth.

Circuit simulators like SPICE or Spectre can perform a noise analysis of a modeled circuit in the frequency domain. To perform the analysis, elements of a particular circuit are first modeled using the conventions of a circuit description language specific to the simulator or using the conventions of a standardized analog behavioral description language, such as Verilog-A or VHDL-A. These conventions define parameters that describe the various elements of the circuit being simulated as well as the placement and power spectral density (PSD) of each noise source in the circuit. The period of the simulation is also defined. These parameters are input into the simulator and the simulator estimates the resulting noise power spectral density of a signal (e.g., a voltage or current) of interest at a specified location in the circuit.

Advanced RF circuit simulators like HSPICE-RF and SpectreRF extend the conventional noise analysis methods described above to periodically time-varying (PTV) systems, thus enabling the noise on a periodic transient waveform to be simulated. In some embodiments, the noise on a periodic transient waveform is represented in the frequency domain by the noise power spectral density (PSD). In other embodiments, the noise is represented in the time domain by the RMS variation of the noise within the nominal periodic steady-state waveform at multiple points in time.

Combining the nominal periodic steady-state waveform and the noise on the nominal periodic steady-state waveform results in a noisy periodic waveform of the selected output in the electronic circuit. In some embodiments, the noisy periodic waveform is represented in the frequency-domain by a Fourier-series representation of the nominal periodic steady-state waveform and a noise power spectral density. In other embodiments, the noisy periodic waveform is represented in the time domain by a time-series representation of the nominal periodic steady-state waveform and the RMS variation of noise within the nominal periodic steady-state waveform at multiple points in time.

In some embodiments, a method of calculating or simulating the transient behavior of circuits due to device mismatches uses the periodically time-varying noise analysis feature of circuit simulators despite the fact that device mismatches are static (DC offsets). In this method, the DC offsets due to device mismatches are replaced (in the circuit model of the circuit being simulated) with noise sources having AC noise parameters that correspond to one or more device mismatch parameters. These noise sources, sometimes herein called pseudo-equivalent AC noise sources, produce noise having power spectral densities concentrated in a low frequency range. As noted above, in some embodiments the one or more noise sources (used to simulate the transient behavior of a circuit due to one or more device mismatches) may be 1/f, 1/f³ or

$$\frac{1}{{f}^{n}}$$

noise sources. The PSD of the noise produced by a 1/f, 1/f³ or

$$\frac{1}{{f}^{n}}$$

noise source decreases with frequency as a function of 1/f, 1/f³ or

$$\frac{1}{{f}^{n}} ,$$

respectively. As a result, the 1/f; 1/f³ or

$$\frac{1}{{f}^{n}}$$

noise produced by the noise source has very low PSD at the fundamental operating frequency f₀ of the circuit being simulated in comparison with the PSD of the noise at a predefined low frequency f₁, where f₁ is typically at or below 100 Hz. In some embodiments, the PSD of a noise source used to model a respective device mismatch is much greater (e.g., by at least a factor of 100) than its PSDs at frequencies beyond the fundamental operating frequency f₀ of the periodic circuit whose operation is being simulated. The method takes advantage of the fact that, for a sufficiently short period of observation or simulation time, the DC mismatch and the pseudo-equivalent AC noise have almost indistinguishable effects on the circuit transient behavior, since a low-frequency noise stays virtually constant for a short, bounded period of time.

The method of simulating device mismatch effects using pseudo-equivalent AC noises is much faster than using conventional Monte-Carlo methods, particularly when simulating transient circuit behaviors. This speed of calculation is achieved by exploiting the faster execution time of noise analysis available in many circuit simulators and by avoiding the need to perform hundreds of simulations to measure transient circuit characteristics. In some cases, the described method is more than 100 times faster than Monte-Carlo methods.

In applying the method, the device mismatches (e.g., DC offsets) of the various circuit elements are first translated into pseudo-equivalent AC noise sources. These DC offsets are generally characterized by mismatch statistics. As discussed, the pseudo-equivalent AC noise sources are chosen to be low-frequency noises so that they stay virtually constant over the simulation period. Then, the pseudo-equivalent AC noise sources are appropriately combined with the modeled circuit elements and input into the simulator. A signal (e.g., a voltage or current) of interest at a location in the circuit is selected as an output and the simulation is executed. The output of the simulation can be a frequency domain output or a time domain output.

In the frequency domain, the output of the simulation is a Fourier-series representation of a periodic steady-state waveform and a noise PSD of the signal of interest. The noise PSD of the signal of interest is translated back into a statistical variation of a circuit parameter of interest. In the time domain, the output of the simulation is a periodic steady-state waveform and associated RMS variation of noise, which are translated back into a statistical variation of a circuit parameter of interest.

PTV noise analysis provided by RF circuit simulators like HSPICE-RF and SpectreRF enables mismatch effects on transient circuit behaviors to be analyzed using the aforementioned method. The ability of analyzing mismatch effects on transient circuit behaviors distinguishes this method from other non-Monte-Carlo methods such as DCMATCH analysis feature available in HSPICE and Spectre. However, a restriction is that the transient circuit behavior on which mismatch effects are to be analyzed must be periodic. This can be enforced by a proper simulation setup. For example, the periodic state of a logic chain can be enforced by having periodic input stimuli.

Some circuit simulators including SpectreRF can also perform a sensitivity analysis. A sensitivity analysis provides a breakdown of individual noise source contributions to the total output noise. When this feature is used with the mismatch analysis method described herein, the simulator determines which device mismatch(es) most influences the parameter of interest. This information can be used to assist in yield optimization. Estimating correlations between different voltages sampled at different times is also possible, thereby determining even more elaborate statistics such as differential nonlinearity (DNL).

To take advantage of the noise analysis features of circuit simulators, random variations (mismatch parameters) in resistance, capacitance, and inductance, as well as variations in threshold voltage and current factor (k) of a MOS transistor are first translated into AC noise sources and combined with the modeled circuit as current or voltage noise sources. This translation takes advantage of the fact that while circuit simulators do not accept circuit definitions in which circuit characteristics such as resistance, capacitance, inductance and the like include noise, circuit simulators but do accept voltage noise and current noise as inputs.

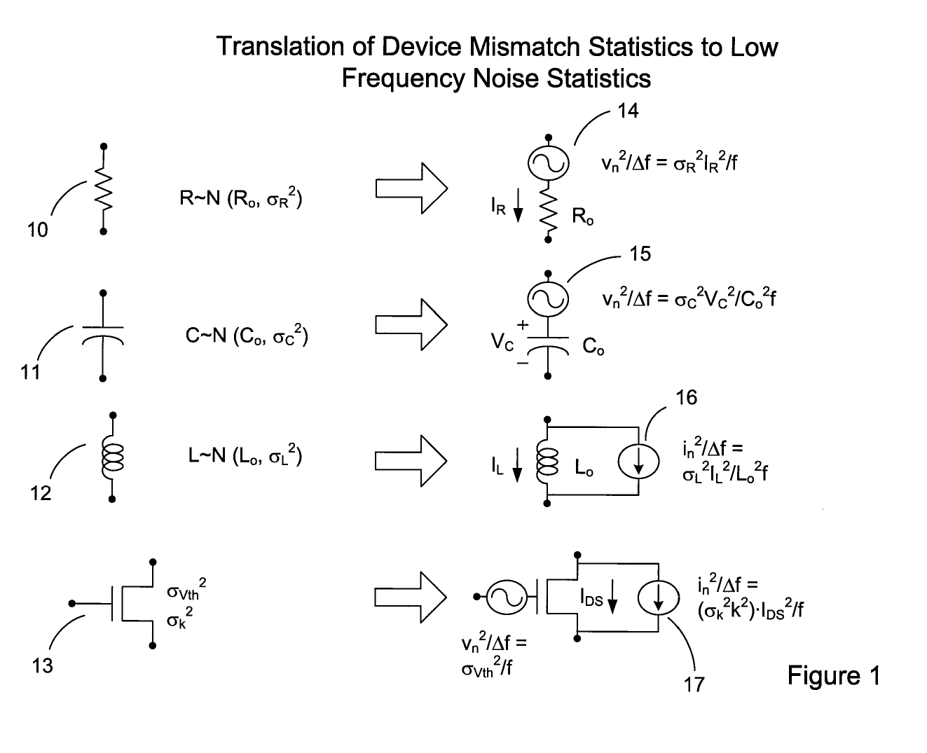

FIG. 1 illustrates the translation of circuit elements with mismatch statistics into circuit elements with noise sources. FIG. 1 shows circuit elements modeled with mismatch statistics, including mismatch modeled resistor 10, capacitor 11, inductor 12, and a MOS transistor 13. FIG. 1 also shows the translation of the circuit elements modeled with mismatch statistics into corresponding circuit elements modeled with pseudo-equivalent noise sources (i.e., noise sources having AC noise parameters that correspond to one or more device mismatch parameters), including noise modeled resistor 14, capacitor 15, inductor 16, and MOS transistor 17. As previously mentioned, the PSD of the modeled noise sources is concentrated at low frequencies. Consequently, the PSD of the modeled noise sources is selected so as to minimize high frequency noise components. In FIG. 1, the equivalent voltage or current variation due to the mismatch, with standard deviation of σ, is translated to a 1/f noise with a PSD that is proportional to σ² at 1 Hz (i.e., noise power∝σ²Δf/f). The circuit elements with their respective noise parameters can then be input into the simulator for analysis of a particular voltage or current of interest.

Since only one or two frequency points on the PSD are used in the translation between a circuit characteristic mismatch and noise, the noise PSD (of the modeled noise sources added to a circuit model for simulation) does not have to be a function of 1/f, but can be a function of 1/f², 1/f³, or f⁻ⁿ where n is greater than one, as long as the noise PSD has negligible high-frequency power such that noise folding or harmonic generation does not contaminate the noise power in the low-frequency range. Also, the noise PSD can be arbitrarily scaled up or down if necessary since the noise analysis is a linear analysis. Moreover, the equivalent noise power need not be fixed, but can vary depending on the circuit's condition. Such bias-dependent noise sources can be conveniently modeled using the Verilog-A model description language as well as other circuit description languages.

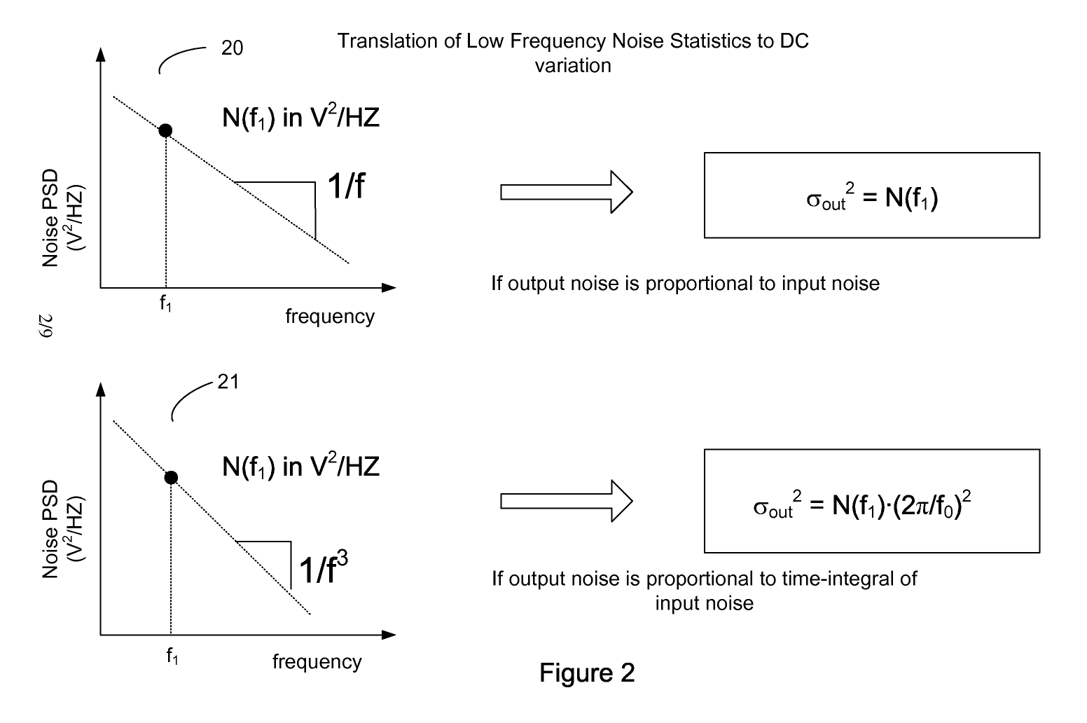

Once the PSD of a circuit signal of interest is obtained by running the simulation, the PSD of the signal of interest is translated back into a measurement of the variability of a circuit parameter. FIG. 2 depicts an embodiment of two methods of translating output noise PSD, produced by a circuit simulator while simulating the circuit of interest, to DC variation of a voltage or current of interest in the circuit. Plot 20 illustrates the PSD of a typical, prophetic simulator output voltage. In this case the PSD of the output noise is proportional to the PSD of the input noise. The output noise PSD in this prophetic example is observed to be proportional to 1/f, and therefore the output noise in this example is called 1/f noise. Consequently, the translation may be performed by applying the following equation.

σₒᵤₜ²=N(fₜ),

where f₁ is an arbitrary frequency (e.g., a predefined frequency such as 1 Hz) whose period is much larger than the simulation time span (so that the noise stays virtually constant over the simulation time span), N(f) represents the noise PSD at frequency f, and σₒᵤₜ² represents the variability of the circuit parameter of interest (e.g., an output voltage). The variability of the circuit parameter corresponds to the variance of the distribution of possible values of the circuit parameter due to device mismatch.

Plot 21 (FIG. 2) illustrates the PSD of another typical, prophetic simulator output voltage. In this case the PSD of the output noise is proportional to the time-integral of the PSD of the input noise. The output noise PSD in this prophetic example is observed to be proportional to 1/f³, and therefore the output noise in this example is called 1/f³ noise. Consequently, the translation may be performed by applying the following equation.

σₒᵤₜ²=N(f₁)·4π²/f₀²,

where f₁ is an arbitrary frequency (e.g., a predefined frequency such as 1 Hz) whose period is much larger than the simulation time span, and f₀ is the fundamental frequency of the steady-state output waveform of circuit. For some circuits, f₀ is above 1 MHz; while for some other circuits f₀ is above 100 MHz, and for yet other circuits f₀ is above 1 GHz. In some embodiments, the ratio between f₀ and f₁ is at least 10⁶ to 1, while in some other embodiments the ratio between f₀ and f, is at least 10⁴ to 1.

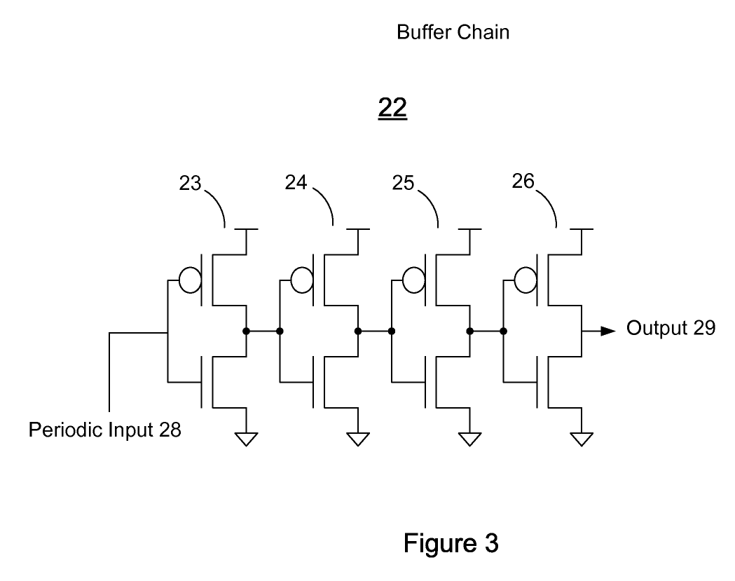

The method of predicting mismatch effects on transient circuit behaviors will be demonstrated using a typical buffer chain having mismatch variations. FIG. 3 is an embodiment of a buffer chain 22. In this example, buffer chain 22 includes four CMOS buffers 23-26, cascaded in series. In some embodiments, a buffer chain may have more or fewer buffers. Each buffer includes an N-type MOS transistor and a P-type MOS transistor having their gates tied together as well as their respective source and drain tied together. CMOS buffer 23 receives at its gates a periodic input 28. CMOS buffer 26 generates output 29. As periodic input 28 propagates down the buffer chain, each individual buffer adds some time delay resulting in an overall time delay of the buffer chain 22. The variation of the overall delay of the buffer chain as a result of mismatch of the transistors in CMOS buffers 23-26 is of particular interest to circuit designers. This variation can be obtained using the noise simulation method described above.

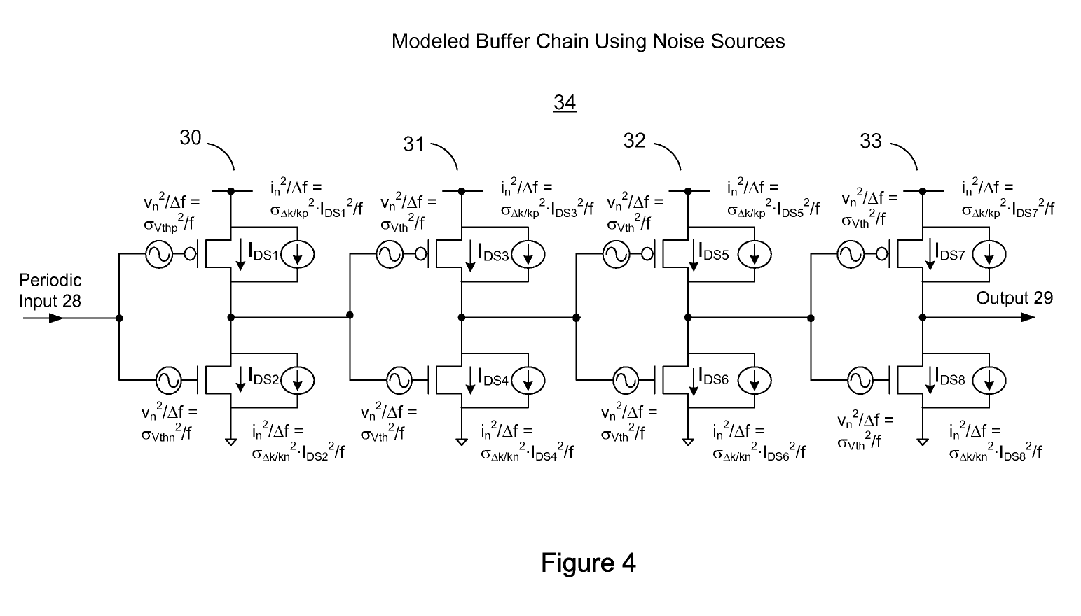

FIG. 4 is an embodiment of a modeled buffer chain combining noise sources with the model elements shown in FIG. 1. Modeled buffer chain 34 includes four modeled MOS buffers 30-33, cascaded in series. Each buffer includes an N-type MOS transistor model and a P-type MOS transistor model, examples of which are shown in FIG. 1. Each of modeled buffers 30-33 have their gates tied together as well as their respective source and drain tied together. Modeled MOS buffer 30 receives at its gates a periodic input 28. Modeled MOS buffer 33 generates output 29. As periodic input 28 propagates down the buffer chain, each individual buffer adds some time delay resulting in an overall time delay of the buffer chain 22. In each case, the MOS transistor has been modeled as having a noise source at its gate that simulates threshold voltage mismatches between the transistors in the buffers. Further, in this example, each MOS transistor in the buffers 30-33 has been modeled as having a noise source between its source and drain that simulates current factor (k) mismatches between the MOS transistors in the buffers. The current factor (k) relates the voltages applied to an MOS transistor to the drain current of the MOS transistor. The parameters of modeled buffer chain 34 are then input into a circuit simulator, such as ADS, SpectreRF, and HSPICE-RF, or any other simulator capable of simulating noise in electronic circuits.

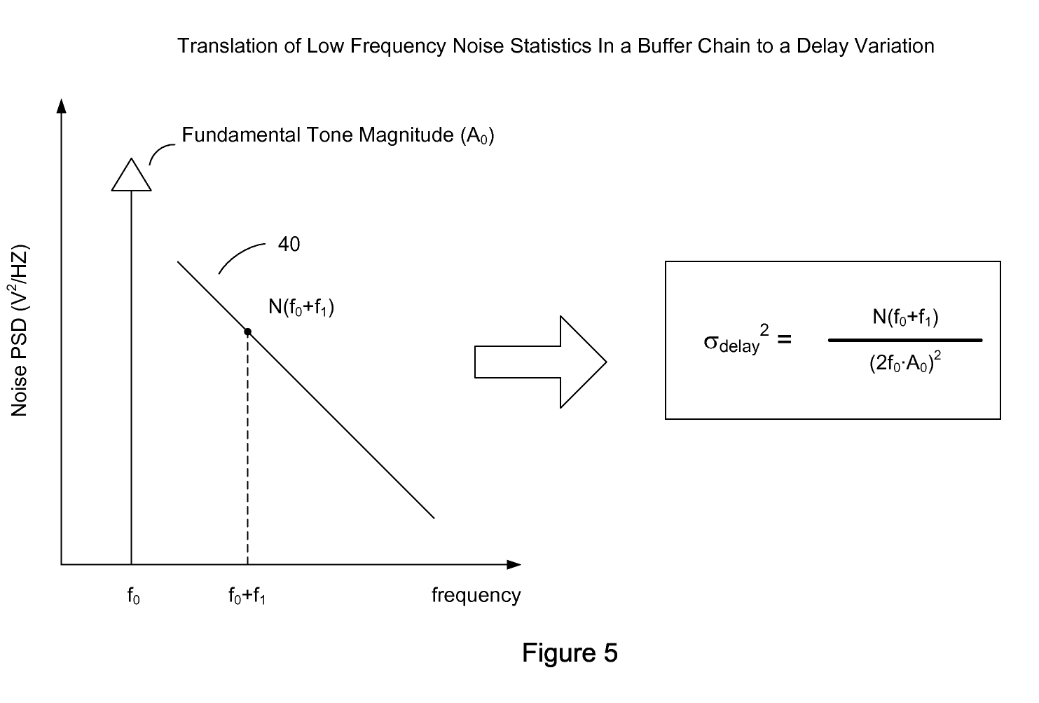

FIG. 5 shows how the output of a circuit simulator can be used to generate the delay variation of the buffer chain 22 using a frequency-domain periodic noise analysis. Plot 40 represents the output PSD of the simulator where the buffer chain is excited by a square wave having a fundamental frequency f₀. Also shown is the fundamental tone magnitude of the square wave having amplitude A₀. The frequency f₁ is the frequency that is used for translation from mismatch parameters to noise parameters. From (i) the fundamental tone magnitude A₀, (ii) f₀ and f₁, and (iii) the noise PSD at frequency f₀+f₁, the delay variation σ_{delay} for the buffer chain circuit can be calculated using the following equation:

σ²_{delay}=N(f₀+f₁)/4(f₀−A₀)².

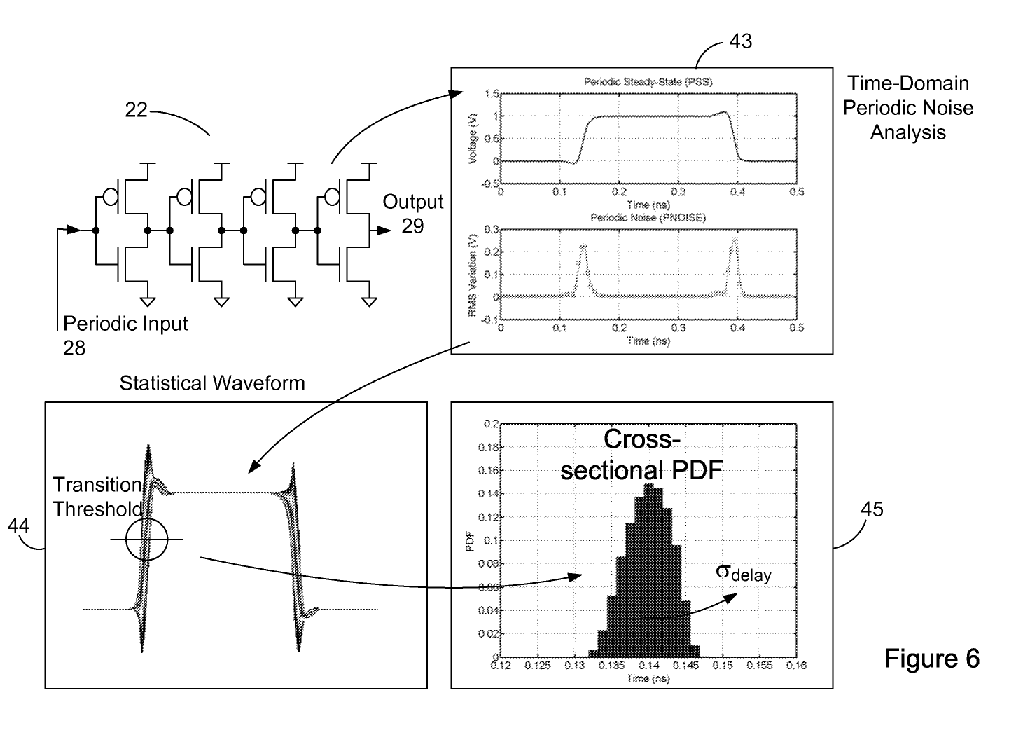

FIG. 6 shows how a circuit simulator can be used to generate the delay variation of the buffer chain 22 using a time-domain periodic noise analysis. To determine delay variation in the buffer chain 22 due to transistor mismatch using the proposed method, the SpectreRF simulator, for example, is configured to calculate a cyclostationary noise PSD at different time points, from which we can derive the voltage statistics of the output 29 over time. The voltage at output 29 is shown in time-domain plot 43 and includes the periodic steady state output of the buffer chain and the RMS variation of the output noise. The periodic steady state output component of the voltage output at output 29 can be represented by a time-series representation. In this example, the variance (of the buffer delay) is equal to the PSD at 1 Hz. By superposing the voltage variation onto the nominal voltage waveform (periodic steady-state response), a statistical voltage waveform 44 is constructed. Then, the delay distribution of the buffer chain is derived from the cross-sectional probability distribution 45 at a voltage equal to the transition threshold, thus yielding the delay variation.

In this example, the simulated variation in delay, produced using the noise analysis simulation method, is very close (within a predefined simulator tolerance bound) to the results produced using a Monte-Carlo simulation method. Other simulated voltage noise-to-timing variation conversions can be used to generated predicted phase interpolator INL, as well as other circuit delay measurements.

The delay variation can also be calculated by using the equation

σ_{delay}=σ_{voltage}/(dV/dt)

at the transition threshold of the delay buffers, but the previously described methods tend to give more accurate results when the time resolution is coarse and the slope is not linear.

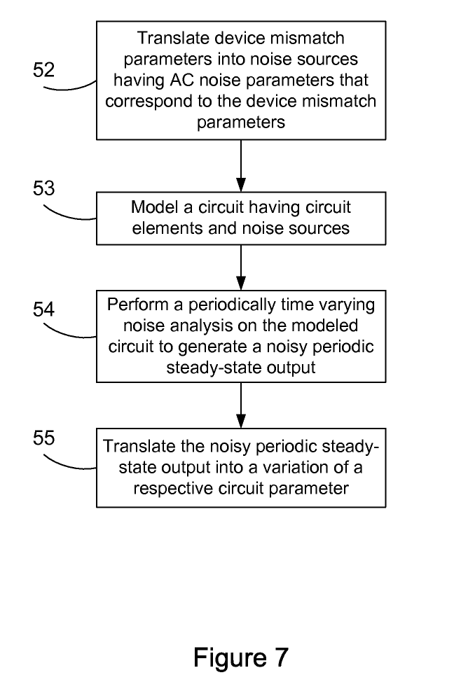

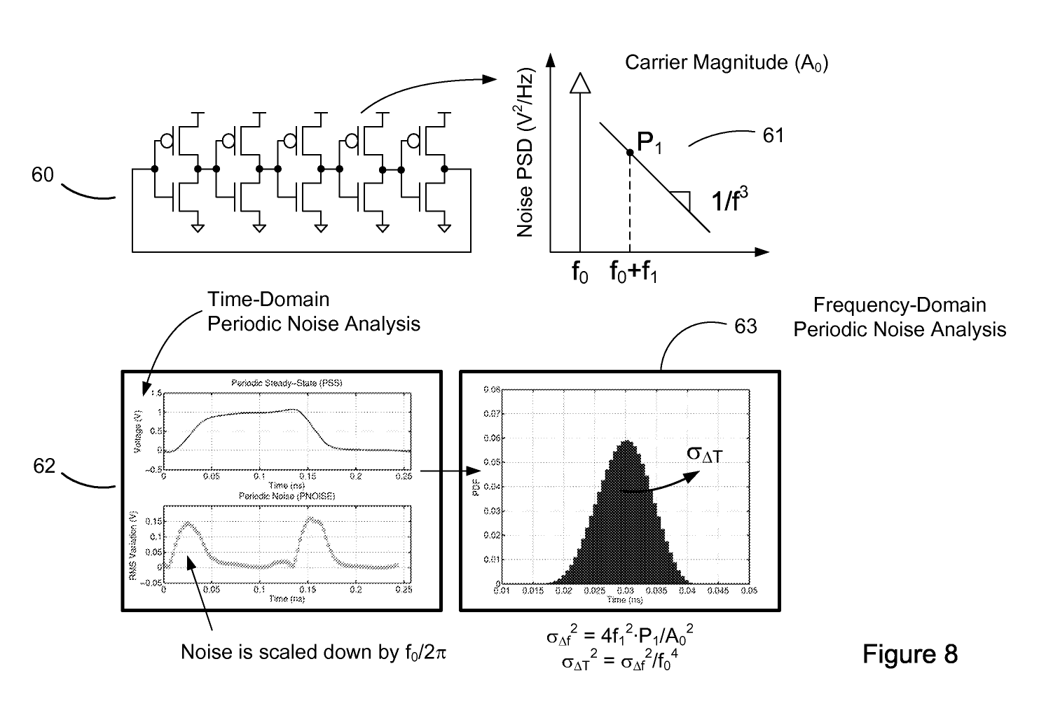

FIG. 7 is a flow chart illustrating an embodiment of the method of simulating device mismatch effects on the transient circuit behaviors of an electronic circuit. The method includes translating device mismatch parameters into noise sources having AC noise parameters that correspond to the device mismatch parameters (52). Then a circuit having circuit elements and the noise sources is modeled (53). A periodic time-varying noise analysis is performed on the modeled circuit to generate a noisy periodic steady-state output (also called a noisy periodic waveform) at a selected output of the electronic circuit (54), and the resulting noisy periodic steady-state output is translated into a prediction of the variation of a respective circuit parameter (55). In some embodiments, discussed below with reference to FIG. 8, the noisy periodic waveform for the selected output is represented in the frequency domain by a Fourier-series representation of a nominal periodic steady-state waveform and a noise power spectral density of the selected output of the electronic circuit. In some other embodiments, as discussed above with reference to FIG. 6, the noisy periodic waveform is represented in the time domain by a time-series representation of a nominal periodic steady-state waveform and an RMS variation of noise within the nominal periodic steady-state waveform at multiple points in time of the selected output of the electronic circuit.

In some cases, device mismatches may manifest themselves in quantities accumulated over time. An example is the variation in frequency of a ring oscillator, where the simulated voltage noise is the integral of the device-mismatch noise over time. To convert the accumulated noise to a value (i.e., a predicted value) that is proportional to the mismatch noise, e.g., a variation in clock period or frequency, the voltage noise must be scaled down by the oscillation frequency, and also by some constant scale factors, depending on the particular conventions for defining Fourier transforms in different simulators. As in the delay case, the variation in frequency can be simulated either by time-domain (see left portion of FIG. 8) or by frequency-domain noise analysis (see right portion of FIG. 8). However, the frequency-domain noise analysis is faster in execution as it needs only one simulation point.

FIG. 8 shows how the variation of the period of a ring oscillator due to device mismatches can be determined (i.e., predicted) using either a frequency domain analysis or a time domain analysis. As shown, ring oscillator 60 is similar to the buffer chain from FIGS. 3, 4, and 6, except that an additional buffer has been added and the output of the last buffer in the chain is tied to the input of the first buffer in the chain.

In the frequency domain analysis, produced by performing a noise analysis simulation in the frequency domain, the PSD of the output of the ring oscillator 60 is shown in plot 61. Notably, the output noise is observed to be 1/f³ noise (because the output noise PSD varies in accordance with 1/f³) rather than the 1/f noise used for the input noise parameters. In other words, in a simulation of a model of the ring oscillator 60 that includes noise sources as shown in FIG. 4 for the modeled buffer chain 34, the power of the voltage noise (or current noise) at the output of the ring oscillator 60 varies in accordance with the inverse of the frequency cubed (i.e., 1/f³). By using the power P₁ of the output noise at f₀+f₁ (where, for example, f₁ is a low frequency such as 1 Hz) and the magnitude A₀ of the fundamental carrier (at frequency f₀) of the periodic steady state waveform, the predicted variation of either frequency or period can be calculated using the following equations:

σ_{Δf}=2·P₁/A₀; and

σ_{ΔT}=σ_{Δf}/f₀².

In the time domain, the periodic steady-state waveform and the RMS noise variation of the output of the ring oscillator 60, shown in plot 62, can be used to calculate the variation of the period or frequency of the ring oscillator as shown in distribution graph 63.

In some circuits, the simulated voltage noise may consist of both a proportional noise term and an integral or accumulated noise term. In these cases, decomposition of the simulated voltage noise into proportional and integral components can be accomplished by observing two points in the noise PSD. Assuming a mismatch-equivalent noise PSD that varies in accordance with 1/f, the proportional noise term also has a 1/f PSD while the integral or accumulated noise term has 1/f³ PSD. The decomposition between proportional noise and accumulated noise is computed based on the slope between the two points in the noise PSD. For example, given two points P1 and P2 in a noise PSD (having units of V²/Hz) at frequencies f₀+f₁ and f₀+f₂ (not shown), the ratio of the proportional noise power to the total noise power (P1), gamma (γ), can be derived as follows.

$$- γ - 3 ( 1 - γ ) = \frac{log ( \frac{P 2}{P 1} )}{log ( \frac{f 2}{f 1} )}$$

which, when solved for gamma, yields:

$$γ = \frac{1}{2} ( \frac{log ( \frac{P 2}{P 1} )}{log ( \frac{f 2}{f 1} )} + 3 )$$

Having solved for gamma (γ), the proportional noise power is γP1 and the integral noise power is (1−γ)P1. Once the voltage noise is decomposed into the proportional term and the accumulated terms, the corresponding delay variation or frequency variation can be calculated separately using the methodology explained above.

Mismatches in different circuit parameters of a circuit may be correlated. For example, transistors that are closely placed are likely to have more similar threshold voltages than those that are far apart. Without taking correlation into account and assuming all mismatches are independently random, one can get misleading estimates on the mismatch effects. For example, by assuming that the gates in the local logic path have independent variations in delay, one can over-estimate the minimum total delay while under-estimating the maximum total delay, which is undesirable for reliable timing closure.

While all noise sources in Verilog-A are assumed independent of one another, we can construct correlated noise sources by letting them share common noise sources. For example, assume that X, Y, and Z are independent noises with variance of 1 and zero mean. If we construct new noise sources A and B by the linear combination of X, Y, and Z, e.g., A=a₁X+a₂Y and B=b₁Y+b₂Z, then A and B have variances of a₁²+a₂² and b₁²+b₂², respectively, and their correlation is equal to

$$\frac{{a}_{2} {b}_{1}}{\sqrt{( {a}_{1}^{2} + {a}_{2}^{2} ) \cdot ( {b}_{1}^{2} + {b}_{2}^{2} )}} .$$

Y is the common noise term shared by A and B, reflecting the correlation between them. In general, N correlated noise sources Y₁, Y₂, . . . , Y_{N} constructed by linearly combining N independent noise sources X₁, X₂, . . . , X_{N} each with variance of 1 and mean of 0, i.e.,

Y=AX

have a covariance matrix C equal to:

C=AA^{T}

where X and Y are N-by-1 matrices with {Xᵢ}'s and {Yᵢ}'s, respectively, and A is a N-by-N matrix with real elements. A^{T} is the transpose of the matrix A. The covariance matrix C is defined as C={Cᵢⱼ}'s where {Cᵢⱼ}=cov(Yᵢ,Yⱼ)=E(YᵢYⱼ)−E(Yᵢ)E(Yⱼ).

The correlation matrix can be derived from this covariance matrix since the correlation coefficient between two variables X and Y, ρ(X,Y) is defined as:

$$ρ ( X , Y ) = \frac{cov ( X , Y )}{\sqrt{cov ( X , X ) \cdot cov ( Y , Y )}} .$$

The variations that we observe in circuit performance parameters may have correlations as well. We can calculate this correlation between two performance variations based on their breakdowns of contributions from the individual independent noise sources. In other words, the RF circuit simulator reports the total noise power as a sum of individual contributions from the independent noise sources. This information is available to the user without any additional simulation.

If the two performance results share large contributions from the common noise sources, they are strongly correlated. To determine the correlation between two circuit performance results at two nodes of a circuit (e.g., delay variations at two nodes of the circuit), the covariance is first calculated, by multiplying each noise source's contributions to the two nodes and summing the square-roots of the products. Then, the correlation coefficient is equal to the covariance divided by the product of the two standard deviations (σ_{A}·σ_{B}) of the circuit performance measurements at the two nodes. In some situations, two delays or two other performance parameters will be correlated with respect to variations (caused by device mismatches) induced when the circuit responds to a first sequence of input signals, but uncorrelated when the circuit responds to a second sequence of input signals.

In general, if we have N independent noise sources modeling device mismatches in the circuit and we are interested in the correlations among M different parameters, we can derive an equation

Y=AX

where X is a N-by-1 matrix with N independent noise sources with variance 1 and mean 0 and Y is a M-by-1 matrix denoting variations in the M result parameters. The M-by-N matrix A={Aᵢⱼ} is derived from the breakdown of contributions, e.g., Aᵢⱼ is equal to a square-root of the noise power contribution (expressed in V²/Hz) from the j-th noise source to the i-th result parameter. Then the covariance matrix among the M result parameters are derived as:

C=AA^{T}.

The correlation matrix can be derived from this covariance matrix as previously described.

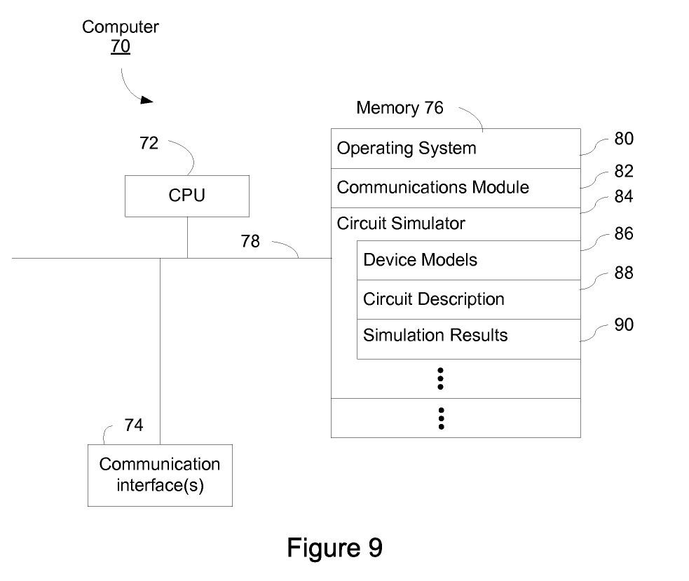

FIG. 9 illustrates a computer 70 that can be used to perform the method described herein. The computer 70 typically includes one or more processing units (CPUs) 72, one or more network or other optional communications interfaces 74, memory 76, and one or more communication buses 78 for interconnecting these components. The communication buses 78 may include circuitry (sometimes called a chipset) that interconnects and controls communications between system components. The front end server 108 may optionally include a user interface comprising a display device and a keyboard. Memory 76 includes high speed random access memory, such as DRAM, SRAM, DDR RAM or other random access solid state memory devices; and may include non-volatile memory, such as one or more magnetic disk storage devices, optical disk storage devices (e.g., CDROM or DVD), flash memory devices, other non-volatile solid state storage devices, or other computer-readable medium. Memory 76 may optionally include one or more storage devices remotely located from the CPU(s) 72. Memory 76 stores the following programs, modules and data structures, or a subset or superset thereof:
an operating system 80 that includes procedures for handling various basic system services and for performing hardware dependent tasks;
an optional network communication module (or instructions) 82 used for connecting the computer 70 to other computers (e.g., client computers or devices, web hosts, server computers) via the one or more optional communication network interfaces 74 and one or more communication networks, such as the Internet, other wide area networks, local area networks, metropolitan area networks, and the like;
a circuit simulator (or instructions) 84 for simulating the operation of one or more specified circuits, including performing time domain and/or frequency domain noise analysis on specified circuits.

The circuit simulator (or instructions) 84 may include device models 86, for modeling devices such as resistors, transistors and other circuit elements; one or more circuit descriptions 88 (e.g., a circuit description specified using a circuit description language, such Verilog-A or VHDL-A); and one or more programs that produce simulation results 90. In some embodiments, the circuit simulator can be executed remotely from a computer at another point in a network coupled to the computer 70 via communication interface 74.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 76 may store a subset of the modules and data structures identified above. Furthermore, memory 76 may store additional modules and data structures not described above.

The method described herein may be performed using various simulation software products along with the additional translation steps. The additional translation steps may be integrated into the software products as add-on software or can be performed using a separate computer program. Alternatively, the method may be implemented in a single software program other than those software programs described herein. Finally, the additional translation steps may be carried out by hand or by using a calculator.

The foregoing descriptions of specific embodiments of the present invention are presented for purposes of illustration and description. They are not intended to be exhaustive or to limit the invention to the precise forms disclosed. Rather, it should be appreciated that many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method of simulating device mismatch effects on transient circuit behaviors, comprising:
providing a circuit model, corresponding to an electronic circuit, the circuit model including a plurality of circuit elements and one or more noise sources, wherein the one or more noise sources have AC noise parameters that correspond to one or more device mismatch parameters associated with one or more circuit elements of the plurality of circuit elements;
performing a periodically time varying noise analysis on the circuit model to generate a simulation output corresponding to a noisy periodic waveform at a selected output of the electronic circuit; and
translating the noisy periodic waveform into a result, the result representing a variation of a respective circuit parameter associated with the electronic circuit.

2. The method of claim 1, wherein the noisy periodic waveform is represented in the frequency domain by a Fourier-series representation of a nominal periodic steady-state waveform and a noise power spectral density of the selected output of the electronic circuit.

3. The method of claim 1, wherein the noisy periodic waveform is represented in the time domain by a time-series representation of a nominal periodic steady-state waveform and an RMS variation of noise within the nominal periodic steady-state waveform at multiple points in time of the selected output of the electronic circuit.

4. The method of claim 1, wherein the mismatch parameters represent DC offsets.

5. The method of claim 1, wherein the one or more noise sources include one or more 1/f noise sources.

6. The method of claim 1, wherein the one or more noise sources include one or more 1/f noise sources, where n is a number greater than one.

7. The method of claim 1, wherein at least one of the noise sources represents voltage noise.

8. The method of claim 1, wherein at least one of the noise sources represents current noise.

9. The method of claim 1, wherein one or more of the AC noise parameters varies in response to a bias level of one or more of the circuit elements.

10. The method of claim 1, further comprising performing a sensitivity analysis on the modeled circuit that provides a breakdown of individual noise source contributions to a total noise of the noisy periodic waveform.

11. The method of claim 10, further comprising using the breakdown of the individual noise source contributions to determine which device mismatch most influences the respective circuit parameter.

12. The method of claim 1, further comprising constructing the AC noise sources from linear combinations of shared independent noise sources to simulate the effects of correlations between two or more mismatch parameters.

13. The method of claim 10, further comprising using the breakdown of individual noise source contributions to simulate correlations between variations in two or more circuit parameters due to device mismatches.

14. The method of claim 1, wherein the variation of the respective circuit parameter is variation of a voltage.

15. The method of claim 1, wherein the variation of the respective circuit parameter is variation of a current.

16. The method of claim 1, wherein the variation of the respective circuit parameter is variation of a time delay.

17. The method of claim 1, wherein the variation of the respective circuit parameter is variation of a frequency.

18. The method of claim 1, wherein the variation of the respective circuit parameter is variation of a time period.

19. The method of claim 1, wherein the variation of the respective circuit parameter is an integral nonlinearity value.

20. The method of claim 1, wherein the variation of the respective circuit parameter is a differential nonlinearity value.

21. The method of claim 1, wherein the noisy periodic waveform is decomposed into a proportional noise term and an integral noise term so that the resulting variations can be calculated separately.

22. A computer-readable medium comprising one or more computer programs that are stored on the computer-readable medium and that are executable by a computer so as to perform a process, the one or more computer programs including instructions for performing a method of simulating device mismatch effects on transient circuit behaviors, the instructions comprising:
instructions for providing a circuit model, corresponding to an electronic circuit, the circuit model including a plurality of circuit elements and one or more noise sources, wherein the one or more noise sources have AC noise parameters that correspond to one or more device mismatch parameters associated with one or more circuit elements of the plurality of circuit elements;
instructions for performing a periodically time varying noise analysis on the circuit model to generate a simulation output representing a noisy periodic waveform at a selected output of the electronic circuit; and
instructions for translating the noisy periodic waveform into a result, the result representing a variation of a respective circuit parameter associated with the electronic circuit.

23. The computer-readable medium of claim 22, wherein the noisy periodic waveform is represented in the frequency domain by a Fourier-series representation of a nominal periodic steady-state waveform and a noise power spectral density of the selected output of the electronic circuit.

24. The computer-readable medium of claim 22, wherein the noisy periodic waveform is represented in the time domain by a time-series representation of a nominal periodic steady-state waveform and an RMS variation of noise within the nominal periodic steady-state waveform at multiple points in time of the selected output of the electronic circuit.

25. The computer-readable medium of claim 22, wherein the mismatch parameters represent DC offsets.

26. The computer-readable medium of claim 22, wherein the one or more noise sources include one or more 1/f noise sources.

27. The computer-readable medium of claim 22, wherein the one or more noise sources include one or more 1/f noise sources, where n is a number greater than one.

28. (canceled)

29. (canceled)

30. (canceled)

31. (canceled)

32. The computer-readable medium of claim 22, further comprising instructions for performing a sensitivity analysis on the modeled circuit that provides a breakdown of individual noise source contributions to a total noise of the noisy periodic waveform.

33. The computer-readable medium of claim 32, further including instructions for using the breakdown of the individual noise source contributions to determine which device mismatch most influences the respective circuit parameter.

34. The computer-readable medium of claim 32, further comprising instructions for using the breakdown of individual noise source contributions to simulate correlations between variations in two or more circuit parameters due to device mismatches.

35. The computer-readable medium of claim 22, further comprising instructions for constructing the AC noise sources from linear combinations of shared independent noise sources to simulate the effects of correlations between two or more mismatch parameters.

36. (canceled)

37. (canceled)

38. (canceled)

39. (canceled)

40. (canceled)

41. (canceled)

42. (canceled)

43. The computer-readable medium of claim 22, wherein the noisy periodic waveform is decomposed into a proportional noise term and an integral noise term so that the resulting variations can be calculated separately.
